(19) United States
(12) Patent Application Publication
(10) Pub. No.: US 2021/0165821 A1
(43) Pub. Date: Jun. 3, 2021

(54) ONLINE PLATFORM FOR ADDRESS-BASED IMAGE HOSTING

(71) Applicant: Rajesh Patel, Fountain Valley, CA (US)

(72) Inventor: Rajesh Patel, Fountain Valley, CA (US)

(21) Appl. No.: 17/174,970

(22) Filed: Feb. 12, 2021

(51) Int. Cl. G06F 16/587; G06F 16/58; G06F 16/54; G06F 16/29; G06F 16/55; G06F 3/0484; G06F 3/0481; H04N 5/232

(52) U.S. Cl. CPC G06F 16/587; G06F 16/5866; G06F 16/54; H04N 5/232933; G06F 16/55; G06F 3/04842; G06F 3/04817; G06F 16/29

(57) ABSTRACT

An online/electronic platform for hosting images, wherein the online platform can associate the images to the geographical address at which the images are taken and the time at which the images are taken. The disclosed platform provides an interface on an electronic device to upload images to the online platform. The interface may also allow a user to capture the images for uploading to the online platform.

### FIELD OF INVENTION

The present invention relates to an online platform for image hosting, and more particularly, the present invention relates to a location-based image hosting.

### BACKGROUND

Image hosting services are known which allows people to upload images on an internet website. The uploader i.e., the person uploading the images or owner of the images can decide with whom the images can be shared. The images can generally be shared among a close private group or open with the public.

The known image hosting services are good in that the images can be shared with others. Such a platform may also allow organizing the images in folder albums or in order of month and year. However, the known image hosting services lack any specific utility or application other than just sharing the images with others.

Thus, a need is appreciated for an online platform for image hosting that provides additional utility or applications.

### SUMMARY OF THE INVENTION

The principal object of the present invention is therefore directed to an online platform for hosting images.

It is an additional object of the present invention that the online platform can provide the exact address where the images were taken for legal and scientific purposes.

It is still an additional object of the present invention that the online platform can assist law enforcement officials in investigations.

It is a further object of the present invention that the online platform can assist the logistic industry in authenticating a delivery.

It is still a further object of the present invention that the online platform organizes images based on location and timeline.

In one aspect, disclosed is an online/electronic platform for hosting images, wherein the online platform can associate the images to the geographical address at which the images are taken and the time at which the images are taken. The disclosed platform provides an interface on an electronic device to upload images to the online platform. The interface may also allow a user to capture the images for uploading to the online platform.

In one aspect, the disclosed online/electronic platform provides an interface for navigating through the uploaded images and viewing one or more images. The online platform may also provide for categorizing the hosted images in the predefined categories and user-defined categories.

### BRIEF DESCRIPTION OF THE DRAWINGS

FIG. 1 shows an interface provided by the online platform for uploading an image, according to an exemplary embodiment of the present invention.

FIG. 2 shows another embodiment of the interface shown in FIG. 1, according to the present invention.

### DETAILED DESCRIPTION

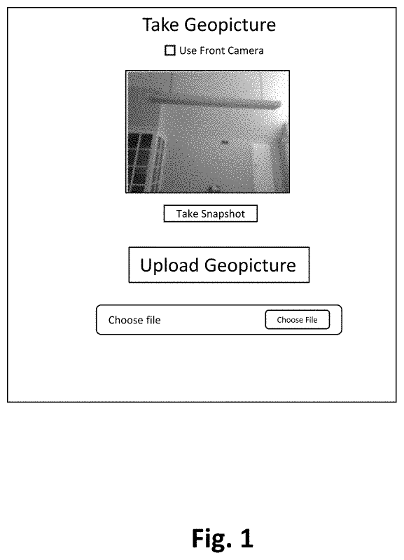

Referring to FIG. 1 which shows an interface for either uploading an image or capturing (snap) an image for uploading to a disclosed online platform. The disclosed platform can associate the received images to the geographic position/address at which the images were taken. Additionally, the images can be associated by the system with the time at which an image was taken.

FIG. 1 shows the interface that allows a user to upload images that have been taken in the past. A user can download the interface on their electronic device, such as smartphone, laptop, desktop, workstation, iPad, tablet computer, and like. The electronic device can include a camera for capturing images. Alternatively, the images which have been captured through another device can be downloaded to the electronic device.

The electronic device may have a network circuitry for connecting to the online platform through a network. The network can be wired or wireless. Wired networks may include Digital Subscriber Line (DSL), coaxial cable lines, or optical fiber lines. The wireless networks may include BLUETOOTH, Wi-Fi, Worldwide Interoperability for Microwave Access (WiMAX), an infrared channel or satellite band, cellular networks such as 2G, 3G, or 4G.

The interface can be provided as an application software on the user's electronic device. In one case, the application software can be downloaded from an application distribution platform, such as App Store, GOOGLE PLAY, Chrome Webstore, and Amazon Appstore. Alternatively, the interface can also be provided through world-wide-web and accessible on the electronic device through a browser, such as Chrome.

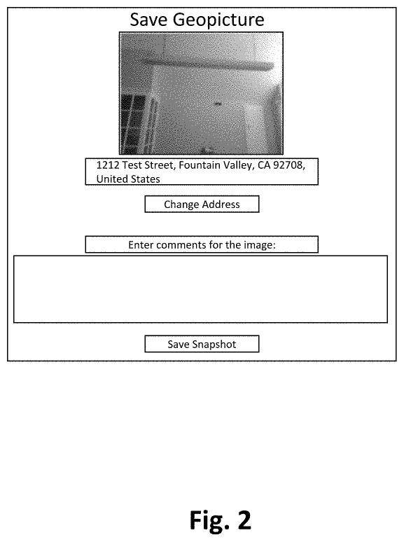

A user can upload an image through the interface using a file system of the electronic device. The interface can retrieve the location coordinates from the metadata of the image. The interface can upload the location coordinate to the disclosed online platform which can then retrieve the exact geographical location of the location coordinates. The geographical location/address can then be displayed on the interface, as shown in FIG. 2. The interface can provide an option to change the address. The user can then save the image to the online platform. It is to be understood that the image can first be uploaded to the online platform and thereafter the geographical location can be displayed on the interface.

FIG. 1 also shows an option to take a snapshot through a camera of the electronic device. The user can capture the snapshot of any object, wherein the interface can also record the location coordinates of the electronic device when the image is captured. These location coordinates can be uploaded to the disclosed online platform which can retrieve the geographic location/address in the form of the address of the location coordinated. The address can include the exact location, nearby landmarks, etc. which can help a person recognize the place.

The uploaded images can be hosted on the online platform which can provide another interface that allows a user to navigate through the uploaded images. The interface can be accessed through the electronic device for the user. For example, another interface can be provided through world-wide-web. The user through a browser or the disclosed application software on the user's electronic device can browse the images on another interface.

The online platform may allow the images to be organized based on the geographical location and time associated with the images. The images can be presented as icons on a map, wherein the location of the icon on the map is the location associated with the image. A user can click or hover over an icon to enlarge the image.

The online platform can organize the images in folders based on the geographical location and time. The interface can also provide search options and filters to access desired images. The filters can be of date, place, landmark, and like. More than one filter can be used, for example, images captured in a place between a date range. The results of the search can be displayed as tiles, thumbnails, slideshow, and like. Moreover, the results can be displayed on a map as an icon, the location of the icon on the map is the exact geographical location. For example, images of a particular day in a city can be displayed as a map of the city with the images shown as icons on their exact geographical address on the map. The interface can also provide an option for displaying the location of an active image on the geographical map. The user can also see the navigation details to reach the location associated with the image. In one case, an option can be provided, wherein activating an image displayed on the interface shows the location associated with the image as an icon on the navigation map. In one case, when the results of a query are displayed as a list, an option can be provided to see one, two, a few, or all the results on the geographical/navigational map. Users can modify anytime if which of the results should be displayed on the map.

The disclosed online platform can be easily integrated into other online platforms, such as navigational maps, image hosting services, trips planner, and like. For example, if a picture, taken on any cellphone, contains important evidence or incriminating information for a crime, this picture can be used as evidence of the exact location, and time is taken and can be used by law enforcement officials. Logistics companies document the delivery of items by snapping a picture of the item, once delivered, and the exact address of where the item was delivered, and the time of delivery, are automatically associated with that picture.

In one case, the disclosed online platform can provide an interface on a user's electronic device. A map can be displayed in the interface, such as a user can zoom in and out or search a location on the map. In one preferred embodiment, a selection tool can also be provided which can allow selecting an area on the map. The online platform can receive the selection from the interface and retrieve the images having associated locations in the selected area. The images can then be displayed as a separate list or icons on the map. The results can be further filtered based on the time associated with the image, the time is the time at which the image was taken. Any date or a date range can be provided to filter the results.

What is claimed is:

1. A method for online image hosting, the method comprising the steps of:
providing, by an electronic platform, a first interface on a user device, wherein the first interface permit a user to upload an image to the electronic platform;
retrieving, by the first interface, location coordinates of a place where the image is taken;
retrieving, by the electronic platform, geographical address of the location coordinates, the geographical address having at least a name of the place;
receiving, by the electronic platform, the image; and
upon receiving the image, associating the geographical address to the image.

2. The method according to claim 1, wherein the method further comprises the step of:
upon receiving the image, associating a time with the image, the time is the time at which the image is taken.

3. The method according to claim 1, wherein the method further comprises the step of:
displaying, by the electronic platform, on the first interface, the geographical address of the image;
permitting, by the first interface, a modification of the geographical address; and
associating, by the electronic platform, the modified geographical address to the image.

4. The method according to claim 1, wherein the first interface permits uploading the image using a file system of the electronic device.

5. The method according to claim 1, wherein the first interface is configured to capture an image using a camera of the electronic device and uploading the captured image in near-real time.

6. The method according to claim 1, wherein the method further comprises the step of:
providing, by the electronic platform, a second interface on the user device;
presenting, a map on the second interface, wherein the second interface comprise a selection tool configured to select an area on the map;
receiving, by the electronic platform, a selection area through the second interface; and
displaying, by the electronic platform, on the second interface, one or more images having their geographical address within the selection area.

7. The method according to claim 6, wherein the one or more images are displayed as icons, wherein the second interface is configured to receive a selection of one icon and presenting an enlarged view of the image associates with the selected icon.

8. The method according to claim 7, wherein the receive the selection is hovering of a cursor over the icon.

9. The method according to claim 6, wherein the method further comprises the step of:
upon receiving the selection area, receiving, by the electronic platform, a date range, wherein the one or more images displayed are within the date range.
